(19) United States
(12) Patent Application Publication
(10) Pub. No.: US 2009/0120259 A1
(43) Pub. Date: May 14, 2009

(54) Cutting tool

(75) Inventors: Robert W. Erickson, Georgetown, TX (US); Jimmie L. Sollami, Herrin, IL (US)

Correspondence Address: JAMES RAY & ASSOCIATES, 2640 PITCAIRN ROAD, MONROEVILLE, PA, 15146, US

(73) Assignee: RIVER CITY MANUFACTURING, INC.

(21) Appl. No.: 11/983,697

(22) Filed: Nov. 9, 2007

(51) Int. Cl. B26D 7/00; E21B 10/43

(52) U.S. Cl. 83/651; 175/427

(57) ABSTRACT

A cutting tool for use on earth working and land clearing equipment includes a working body portion having a continuous slot formed transversely therethrough in open communication with the first end and an exterior surface thereof. A cutting insert having a V-shaped notch formed in the front cutting end thereof is positioned and rigidly secured within the slot. A mounting shank extends outwardly from and is attached to the second end of the working body portion for enabling attachment of the cutting tool to a tool holder used on such earth working and land clearing equipment.

### CROSS-REFERENCE TO RELATED APPLICATIONS

This application is closely related to U.S. Utility patent application Ser. No. 10/733,607 filed on Dec. 11, 2003, to U.S. Utility patent application Ser. No. 11/067,439 filed on Feb. 25, 2005, to U.S. Utility patent application Ser. No. 11/150,508 filed on Jun. 10, 2005 and to U.S. Utility patent application Ser. No. 11/150,509 filed on Jun. 10, 2005. These applications being assigned to the assignee of the present invention and the disclosure of these applications is hereby incorporated by reference thereto.

### FIELD OF THE INVENTION

The present invention relates, in general, to cutting tools and, more particularly, this invention relates to a non-rotating cutting tool for use on earth working and land clearing equipment and, yet more particularly, the instant invention relates to a non-rotating cutting tool for use on earth working and land clearing equipment which includes a V-shaped cutting insert for improving cutting and clearing of brush and trees.

### BACKGROUND OF THE INVENTION

As is generally well known, one style of cutting tool which is widely used on earth working and land clearing equipment includes a conical pointed working end and a mounting portion which is often an elongated shank extending along the longitudinal axis of the cutting tool. Such elongated shank is received within an aperture of a tool holder or a support block which is in turn welded to a chain attachment or a rotatable drum of such earth working and land clearing equipment. The cutting tool is then secured to the tool holder or the support block either with external retaining clips disposed within the groove formed at the rear free end of the shank and engaging the rear surface of such tool holder or with retaining pins engaging an aperture formed within the support block and a complimentary groove formed in the shank. The employment of internally disposed retaining pins facilitates ease of replacement of such cutting tool during use.

It has been found that in applications of clearing land having lush vegetation with small diameter trees and brush and where disturbance of the ground surface is prohibited, the cutting tools with the pointed working end resulted in undesirable bending of such vegetation causing stubs of six inches and longer to protrude from the ground surface. Such condition is undesirable, as it requires additional clearing effort to completely remove the stubs and reuse the land.

Therefore, there is a need for an improved cutting tool that is better suited for, economical clearing of lush vegetation in close proximity to the ground surface.

### SUMMARY OF THE INVENTION

According to one embodiment, the present invention provides a cutting tool for use on at least one of earth working and land clearing equipment. The cutting tool includes a working body portion which has each of a predetermined shape and a predetermined size. The working body portion also has a first end and a second end spaced from the first end along a longitudinal axis of the cutting tool. A continuous slot is formed transversely through the working body portion in open communication with the first end and an exterior surface thereof. A cutting insert is positioned and rigidly secured within the slot. The cutting insert has each of a predetermined size and a predetermined shape and is formed from a predetermined material. The cutting insert also has a front cutting end, an opposed rear seating end, a top opposed surface and a bottom opposed surface. A V-shaped notch is formed in the front cutting end of the cutting insert, whereby wall surfaces of the V-shaped notch are disposed generally symmetrical relative to the longitudinal axis of the cutting tool and taper at a predetermined angle from the cutting end inwardly toward the rear seating end of the cutting insert. There is a mounting shank which has each of a predetermined shape and a predetermined size for enabling attachment of the cutting tool to an outer surface of a rotating carrier mounted within such at least one of such earth working and land clearing equipment. A first end of the mounting shank has a first predetermined diameter and is disposed on and secured to the second edge of the working body portion. A second end of the mounting shank has a second predetermined diameter and extends outwardly from the second end of the working body portion along the longitudinal axis of the cutting tool.

According to another embodiment of the invention, there is provided a non-rotating cutting tool for use on at least one of earth working and land clearing equipment. Such cutting tool includes a working body portion having each of a predetermined shape and a predetermined size and having a first end and a second end spaced from the first end along a longitudinal axis of the cutting tool. A V-shaped cutting edge is disposed on and secured to the first end of the working body portion. A mounting means is engageable with the second end of the working body portion for enabling attachment of the cutting tool to an exterior surface of a rotating carrier mounted within such at least one of such earth working and land clearing equipment.

According to yet another embodiment, the present invention provides a cutting tool for use on at least one of earth working and land clearing equipment. The cutting tool includes a working body portion which has a first end with a first planar surface. An opposed second end has a second planar surface. A peripheral tapered side surface joins the first and the second ends. The peripheral side surface has a generally square cross-section throughout and is defined by a quartet of corner edges. Each corner edge has a first end thereof extending past the first planar surface of the first end of the working body portion and has a second end thereof connected to the second planar surface of the second end of the working body portion. Each corner edge tapers inwardly from the first end toward the second end. Four insert seats are formed in the first end. Each insert seat has a triangular planar surface starting at the first end of a respective corner edge, inclining downwardly toward the first planar surface and a forming a positioning ledge disposed generally perpendicular and inwardly to the first planar surface of the first end of the working body portion. Four triangular shaped cutting inserts are provided with each cutting insert rigidly secured to a respective insert seat. An inner edge of the cutting insert engageably abuts the ledge formed in the first end of the working body portion. Tapered exposed edges of the cutting insert are formed in alignment with the tapered peripheral side surface. A mounting shank portion has a first end thereof secured to the second end of the working body portion for enabling attachment of the cutting tool to an outer surface of a rotating carrier mounted within such at least one of such earth working and land clearing equipment.

### OBJECTS OF THE INVENTION

It is, therefore, one of the primary objects of the present invention to provide an improved cutting tool for use on earth working and land clearing equipment.

Another object of the present invention is to provide a cutting tool for use on earth working and land clearing equipment that improves clearing of lush vegetation and small diameter trees and shrubs in close proximity to a ground surface.

Yet another object of the present invention is to provide a cutting tool for use on earth working and land clearing equipment that is economical to manufacture.

A further object of the present invention is to provide a cutting tool for use on earth working and land clearing equipment that can be easily removed from the tool holder.

Yet a further object of the present invention is to provide a cutting tool for use on earth working and land clearing equipment that requires simple tools for its removal from the tool holder.

An additional object of the present invention is to provide a cutting tool in combination with the tool holder for use on earth working and land clearing equipment that promotes slicing action during use.

Another object of the present invention is to provide a cutting tool for use on earth working and land clearing equipment that employs a carbide cutting insert having a V-shaped notch formed therein.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a side view of a cutting tool constructed according to one embodiment of the invention;

FIG. 2 is top view of the cutting tool of FIG. 1;

FIG. 3 is a cross-sectional view of the cutting tool along lines 3-3 of FIG. 1;

FIG. 4 is a partial end view of the cutting tool along lines 4-4 of FIG. 2;

FIG. 5 is an environmental view particularly illustrating the cutting tool of FIG. 1 secured to a support block attached to a rotating drum;

FIG. 6 is a side view of a cutting tool constructed according to another embodiment of the invention;

FIG. 7 is an end view of the cutting tool of FIG. 6;

FIG. 8 is a partial cross-sectional view of the cutting tool of FIG. 6 along lines 8-8 of FIG. 7; and

FIG. 9 is a side view of a cutting tool constructed according to yet another embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

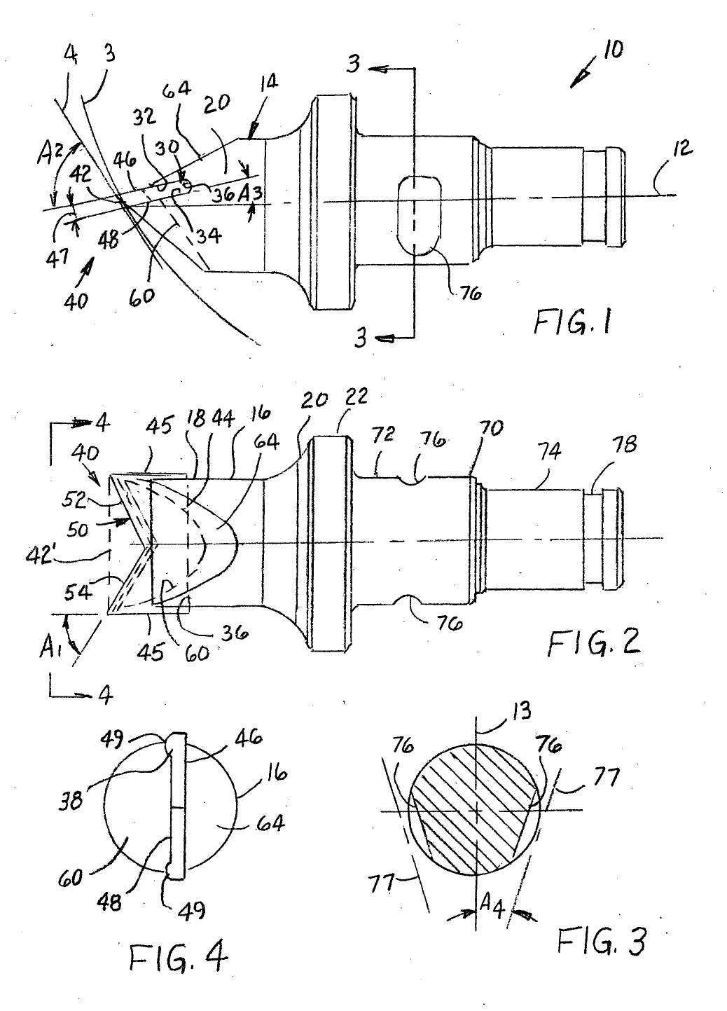

Reference is now made, to FIGS. 1-5, wherein there is shown a cutting tool, generally designated as 10, which is constructed in accordance with one embodiment of the invention for use on earth working and land clearing equipment which is illustrated in FIG. 5 as a drum 2 rotating in a clockwise direction. Particularly, the tool 10 is detachably secured to a support block 80 which is shown in FIG. 5 and which is disclosed in closely related U.S. Utility patent application Ser. No. 11/150,508 and U.S. Utility patent application Ser. No. 11/150,509.

The cutting tool 10 includes a working body portion 14 having each of a predetermined shape and a predetermined size. The presently preferred working body portion 14 is formed by a cylindrical member 16 which carries thereon a first end 18 and a second end 20 of the working body portion 14. The second end 20 is spaced from the first end 18 along a longitudinal axis 12 of the cutting tool 10. The second end 20 may be adapted with an annular flange 22 for abutting a front surface 82 of the support block 80.

In the presently preferred embodiment of the invention, the working body portion 14 includes a continuous slot 30 which is formed transversely through the cylindrical member 16 in open communication with the first end 18 and an exterior surface 20 of the working body portion 14. The slot 30 is defined by a pair of opposed surfaces 32, 34 and a bottom end 36.

Operably mounted within the slot 30 is a cutting insert, generally designated as 40, which has each of a predetermined size and a predetermined shape and which is formed from a predetermined material. The cutting insert 40 is defined by a front cutting end 42, an opposed rear seating end 44, a top opposed surface 46 and a bottom opposed surface 48. The cutting insert 40 is rigidly secured within the slot 30 by a brazing method, whereby the rear sitting end 44 is disposed in abutting relationship with the bottom end 36 of the slot 30 and wherein the front cutting end 42 and the rear seating end 44 are disposed generally perpendicular to the longitudinal axis 12 of the cutting tool 10.

Preferably, each of the top surface 46 and the bottom surface 48 is generally planar and being substantially parallel to each other. Thus, the cutting insert 40 has a generally uniform thickness, of about 0.19 inches, defined by a distance 47 between the top and the bottom surfaces, 46 and 48 respectively. The presently preferred shape of the cutting insert 40 includes a generally rectangular cross-section taken in a plane which is substantially parallel to each of the top surface 46 and the bottom surface 48. The presently preferred length of the of the cutting insert 40 is about 1.63 inches and the width is about 0.75 inches

The predetermined material of the cutting insert 10 may be selected from a group consisting of tungsten carbide, diamond coated tungsten carbide, ceramic and various combinations thereof. The presently preferred material is tungsten carbide.

It has been found advantageous to extend at least the front cutting end 42 past the exterior surface 20 of the working body portion 14 in order to enable repeated sharpening of such front cutting end 42. Preferably, the side edges 45 of the cutting insert 40 also extend past the exterior surface 20 of the working body portion 14 as it has been found that during use of the cutting tool 10 such side edges 45 participate in the cutting process. Therefore, it is necessary to sharpen such side edges 45 in addition to the front cutting end 42.

The front cutting end 42 may be straight, as indicated by reference numeral 42′ in FIG. 2, and, preferably, there is provided a V-shaped notch 50 which is formed in the front cutting end 42 of the cutting insert 40, whereby wall surfaces 52, 54 of the V-shaped notch 50 are disposed generally symmetrical relative to the longitudinal axis 12 of the cutting tool 10 and taper at a predetermined angle, preferably being about 30 degrees, from a juncture of the cutting end 42 with a respective side edge 45 inwardly toward the rear sitting end 44 of the cutting insert 40. Furthermore, wall surfaces 52, 54 of the V-shaped notch 50 taper inwardly from the top surface 46 toward the bottom surface 48. In operation, the V-shaped notch 50 increases the length of the cutting edge. The presently preferred depth of the V-shaped notch 50 is about 0.25 inches. The generally acute angle A₁ formed by the juncture of the wall surface 52, 54 with the respective side edge 45 facilitates piercing of the material to be cut and enhances performance of the cutting tool 10.

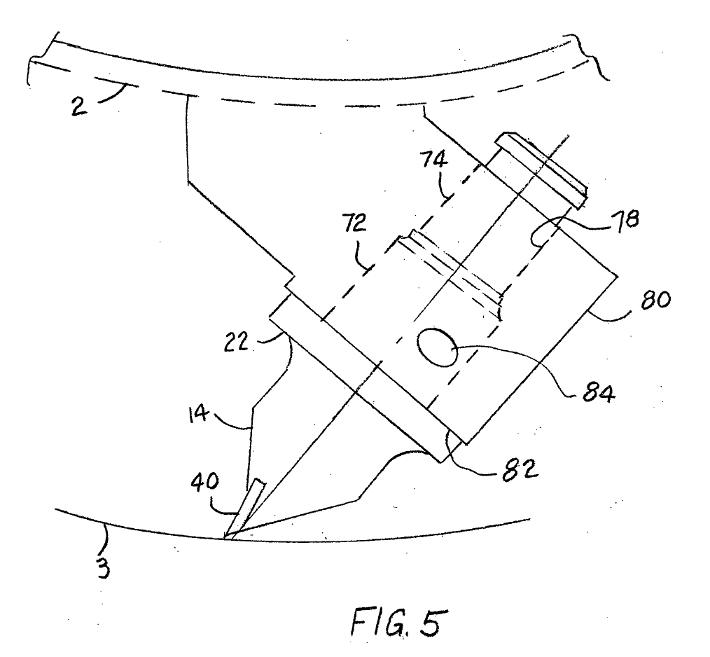

To facilitate centering of the cutting insert 40 within the slot 30, the bottom surface 48 may be adapted with a pair of spaced apart elongated tabs 49 as best shown in FIG. 4. Accordingly, a pair of cavities 38 will be formed in the bottom surface 34 of the slot 30 to accommodate such elongated tabs 49. It has been also found that during use, elongated tabs 49 increase the thickness of each edge 45 and, more particularly, increase strength of the cutting insert 40.

To compliment employment of the V-shaped notch 50, the working body portion 14 includes a V-shaped groove 60 which is formed in the first end 16 thereof in general alignment with the V-shaped notch 50 of the cutting insert 40. The V-shaped groove 60 is disposed adjacent to and downwardly from the bottom surface 48 of the cutting insert 40 when the cutting tool is mounted on such at least one of earth working and land clearing equipment. To facilitate cutting process, the working body portion 14 is provided with a taper 64 which is formed in the first end 16 and which is disposed adjacent the top surface 46 of the cutting insert 40 when the cutting tool 10 is mounted on such at least one of earth working and land clearing equipment.

In the presently preferred embodiment of the invention, the cutting tool 10 further includes a mounting shank 70 having each of a predetermined shape and a predetermined size for enabling attachment of the cutting tool 10 to such at least one of such earth working and land clearing equipment. The mounting shank 70 has a first end 72 of a first predetermined diameter which is disposed on and secured to the second end 20 of the working body portion 14. A second end 74 of the mounting shank 70 has a second predetermined diameter and extends outwardly from the first end 72 along the longitudinal axis 12 of the cutting tool 10. Preferably, the first predetermined diameter of the first end 72 of the mounting shank 70 is larger than the second predetermined diameter of the second end 74. The mounting shank 70 of the presently preferred embodiment of the invention is adapted for attaching the cutting tool 10 to the support block 80. Preferably, the working body portion 14 and the mounting shank portion 70 are formed as a single piece member by a casting process.

The cutting tool 10 may be allowed to rotate during use, however, it has been found that to improve cutting performance, by promoting a knife-like slicing action and positioning the surfaces 46, 48 of the cutting insert 40 generally horizontally relative to the brush and vegetation to be cut, the cutting tool 10 must be attached in a non-rotating fashion in order to incline the cutting insert 40 at a predetermined angle A₃ to the longitudinal axis 12 of the cutting tool 10 in order to position the cutting insert 40 and, more particularly, its front cutting end 42 at a generally acute angle A₂ to a line 4 which is disposed tangentially to a rotational ark 3 of the cutting insert 40, as best shown in FIG. 1. Accordingly, the mounting shank 70 includes a pair of concave slots 76 formed in an outer surface thereof and opposite from each other relative to the longitudinal axis 12 of the cutting tool 10. Preferably, the concave slots 76 are formed within the first end 72. A longitudinal axis 77 of each concave slot 76 is disposed in a generally vertical direction and at a predetermined angle A₄ to the vertical axis 13 of the cutting tool 10 in order to align each concave slot 76 with the aperture 84 formed in the support block 80. Additionally, the mounting shank 70 may include an optional annular grove 78 formed within the second end 74.

Although, the cutting tool 10 of FIGS. 1-5 has been illustrated in terms of the separated cutting insert 40 being made from a different material and brazed to the working body portion 14, it will be apparent to those skilled in the art that the cutting end 42 having a V-shaped groove 50 may be formed integral to the working body portion 14 during its manufacturing, preferably by a casting process, and heat treated or coated with carbide material to duplicate properties of the above described cutting insert 40 and to provide required strength and durability during use.

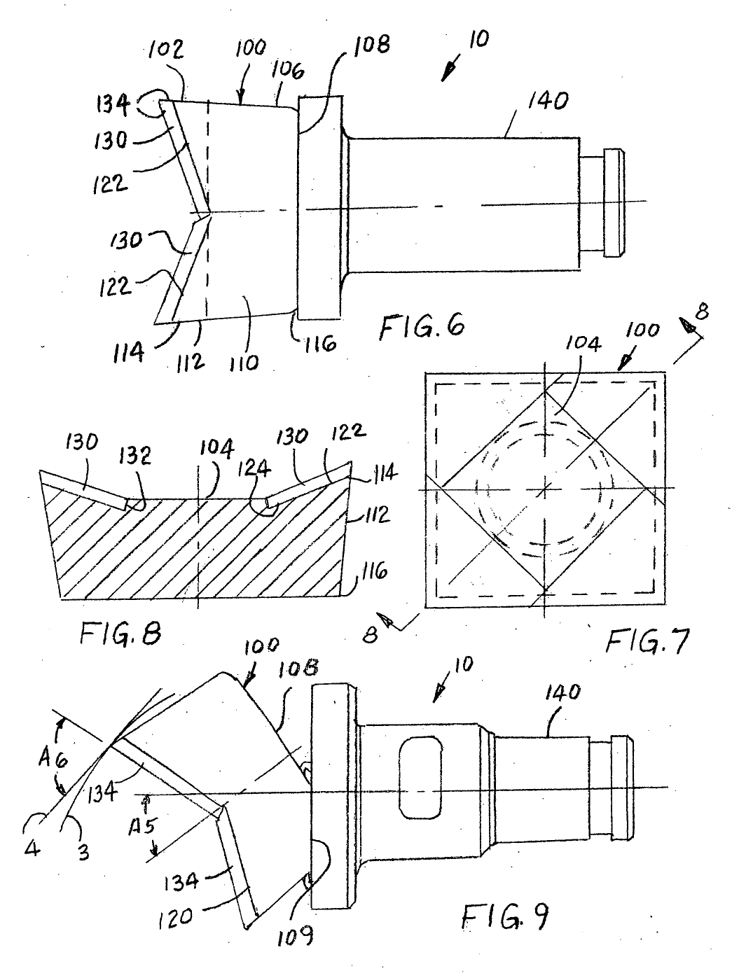

Now in reference to FIGS. 6-9, there is illustrated a cutting tool 10 employing a working body portion 100 which is constructed according to another embodiment of the invention. Such working body portion 100 includes a first end 102 having a first planar surface 104. There is an opposed second end 106 having a second planar surface 108. A tapered peripheral side surface 110 joins the first end 102 and the second end 106. The peripheral side surface 110 has a generally square cross-section throughout and is defined by a quartet of corner edges 112 each having a first end 114 thereof extending past the first planar surface 104 of the first end 102 of the working body portion 100 and having a second end 116 thereof connected to the second planar surface 108 of the second end 106 of the working body portion. Each corner edge 112 tapers inwardly from the first end 102 toward the second end 106. Four insert seats are formed in the first end 102, each having a triangular planar surface 122 starting at the first end 114 of a respective corner edge 112, inclining downwardly toward the first planar surface 104 and a forming a positioning ledge 124 disposed generally perpendicular and inwardly to the first planar surface 104 of the first end 102 of the working body portion 100. Four triangular cutting inserts 130 are provided with each cutting insert 130 being rigidly secured to a respective insert seat, for example such as by the well known brazing process. Each cutting insert 130 has an inner edge 132 abuttingly engaging the positioning ledge 124 formed in the first end 102 of the working body portion 100 and having tapered exposed cutting edges 134 formed in alignment with the tapered peripheral side surface 110. As best shown in FIGS. 6 and 9, the adjacent cutting edges 134 which are disposed in the same plane form the V-shaped groove closely resembling the above described V-shaped groove 50. A mounting shank portion 140, is provided and has a first end thereof secured to the second end 106 of the working body portion 100 for enabling attachment of the cutting tool 10 to an outer surface of a rotating carrier 2 mounted within such at least one of such earth working and land clearing equipment (not shown). The mounting shank portion 140 may be adapted for rotatably mounting the cutting tool 10 to the support block 80 by any well known attachment methods, or may be formed identical to the mounting shank portion 70 described above. In further reference to FIG. 6, the working body portion 100 and the mounting shank portion 140 are formed coaxial to each other preferably as a single piece member by a casting process. Alternatively, as shown in FIG. 9, the working body portion 100 is positioned at a predetermined angle relative to the first end of the mounting shank portion 70 and, more particularly, the longitudinal axis of the working body portion 100 is disposed at a predetermine dangle A₅ to the longitudinal axis of the tool 10 so as to position the surface of the cutting insert 130 at an angle A₆, preferably being less than 90 degrees, to the line 4 which is disposed tangentially to the rotational ark 3 of the cutting insert 120 in order to facilitate knife-like slicing cutting action. Accordingly, the second end 106 includes a taper 109 formed therein. The working body portion 100 may be welded to the mounting shank portion 140 or may be formed integral therewith by a casting process.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A cutting tool for use on at least one of earth working and land clearing equipment, said cutting tool comprising:
(b) a working body portion having each of a predetermined shape and a predetermined size and having a first end and a second end spaced from said first end along a longitudinal axis of said cutting tool;
(c) a continuous slot formed transversely through said working body portion in open communication with said first end and an exterior surface thereof;
(d) a cutting insert having each of a predetermined size and a predetermined shape and formed from a predetermined material, said cutting insert further having a front cutting end, an opposed rear seating end, a top opposed surface and a bottom opposed surface, said cutting insert positioned and rigidly secured within said slot;
(e) a V-shaped notch formed in said front cutting end of said cutting insert, whereby wall surfaces of said V-shaped notch disposed generally symmetrical relative to said longitudinal axis of said cutting tool and taper at a predetermined angle from said cutting end inwardly toward said rear sitting end of said cutting insert;
(f) a mounting shank portion having each of a predetermined shape and a predetermined size for enabling attachment of said cutting tool to an outer surface of a rotating carrier mounted within such at least one of such earth working and land clearing equipment, wherein a first end of said mounting shank portion has a first predetermined diameter and is disposed on and secured to said second end of said working body portion and wherein a second end of said mounting shank portion has a second predetermined diameter and extends outwardly from said second end of said working body portion along said longitudinal axis of said cutting tool.

2. The cutting tool according to claim 1, wherein said cutting tool includes an annular flange formed intermediate said working body portion and said mounting shank portion.

3. The cutting tool according to claim 1, wherein said working body portion further includes a V-shaped groove which is formed in said first end thereof in general alignment with said V-shaped notch of said cutting insert, said V-shaped groove disposed adjacent to and downwardly from said bottom surface of said cutting insert when said cutting tool is mounted on such at least one of earth working and land clearing equipment.

4. The cutting tool according to claim 1, wherein said working body portion further includes a taper which is formed in said first end thereof and which is disposed adjacent to said top surface of said cutting insert when said cutting tool is mounted on such at least one of earth working and land clearing equipment.

5. The cutting tool according to claim 1, wherein said cutting insert has a generally rectangular cross-section taken in a plane which is substantially parallel to each of said top surface and said bottom surface of said cutting insert.

6. The cutting tool according to claim 5, wherein at least said front cutting end of said cutting insert extends past said exterior surface of said working body portion.

7. The cutting tool according to claim 1, wherein each of said top and bottom surface of said cutting insert is generally planar.

8. The cutting tool, according to claim 1, wherein said cutting insert has a generally uniform thickness defined by a distance between said top and said bottom surface.

9. The cutting tool according to claim 1, wherein said top and bottom surfaces of said cutting insert are inclined at a first predetermined angle to said longitudinal axis of said cutting tool in order to position said first cutting end at a second predetermined angle to a surface to be cut when said cutting tool is mounted on such at least one of earth working and land clearing equipment.

10. The cutting tool according to claim 1, wherein said cutting insert includes a pair of elongated tabs each positioned along a respective side edge of said cutting insert and wherein said slot includes a pair of cavities sized and shaped to cooperate with a respective elongated tab.

11. The cutting tool according to claim 1, wherein said first diameter of said first end of said mounting shank is larger than said second diameter of said second end of said mounting shank.

12. The cutting tool according to claim 1, wherein said first end of said mounting shank includes a pair of concave slots formed in an outer surface thereof and opposite from each other relative to said longitudinal axis of said cutting tool.

13. The cutting tool according to claim 12, wherein a longitudinal axis of each concave slot is disposed in a generally vertical direction and at a predetermined angle to said longitudinal axis of said cutting tool when said cutting tool is mounted on such at least one of earth working and land clearing equipment.

14. The cutting tool according to claim 1, wherein said second end of said mounting shank includes an annular grove formed therein.

15. The cutting tool, according to claim 1, wherein said predetermined material of said cutting insert is selected from a group consisting of tungsten carbide, diamond coated tungsten carbide, ceramic and various combinations thereof.

16. A non-rotating cutting tool for use on at least one of earth working and land clearing equipment, said cutting tool comprising:
(a) a working body portion having each of a predetermined shape and a predetermined size and having a first end and a second end spaced from said first end along a longitudinal axis of said cutting tool;
(b) a V-shaped cutting edge disposed on and secured to said first end of said working body portion; and
(c) a mounting means engageable with said second end of said working body portion for enabling attachment of said cutting tool to an outer surface of a rotating carrier mounted within such at least one of such earth working and land clearing equipment.

17. The cutting tool, according to claim 16, wherein said mounting means includes a shank portion having an outer surface thereof engageable with a surface of a bore formed in a support block mounted to an outer surface of such rotating carrier, said shank portion extending through and beyond a bottom surface of such support block.

18. A cutting tool for use on at least one of earth working and land clearing equipment, said cutting tool comprising:
(a) a working body portion including:
(i) a first end having a first planar surface,
(ii) an opposed second end having a second planar surface,
(iii) a tapered peripheral side surface joining said first and said second ends, said peripheral side surface having a generally square cross-section throughout and being defined by four corner edges each having a first end thereof extending past said first planar surface of said first end of said working body portion and having a second end thereof connected to said second planar surface of said second end of said working body portion, said each corner edge tapering inwardly from said first end toward said second end, and
(iv) four insert seats formed in said first end, each having a triangular planar surface starting at said first end of a respective corner edge, inclining downwardly toward said first planar surface and forming a positioning ledge disposed generally perpendicular and inwardly to said first planar surface of said first end of said working body portion;
(b) four triangular-shaped cutting inserts each rigidly secured to a respective insert seat, said each cutting insert having an inner edge thereof abuttingly engageable with said positioning ledge formed in said first end of said working body portion and having tapered exposed edges thereof formed in alignment with said tapered peripheral side surface; and
(c) a mounting shank portion having a first end thereof secured to said second end of said working body portion for enabling attachment of said cutting tool to an outer surface of a rotating carrier mounted within such at least one of such earth working and land clearing equipment.

19. The cutting tool, according to claim 18, wherein said second end of said working body portion is positioned at a predetermined angle relative to said first end of said mounting shank portion.

20. The cutting tool, according to claim 18, wherein said working body portion is disposed coaxially with said mounting shank portion and wherein said cutting tool is formed as a single piece member.
